(19) United States
(12) Patent Application Publication
(10) Pub. No.: US 2023/0103500 A1
(43) Pub. Date: Apr. 6, 2023

(54) SYSTEM AND METHOD FOR MESH-BASED EMERGENCY RESPONSE CONNECTIVITY

(71) Applicant: BUDDY INC., Bel Air, CA (US)

(72) Inventor: Claire WRIGHT, Sherman Oaks, CA (US)

(21) Appl. No.: 17/936,752

(22) Filed: Sep. 29, 2022

Related U.S. Application Data
(60) Provisional application No. 63/261,997, filed on Oct. 1, 2021.

(51) Int. Cl. H04W 40/24; H04W 4/90

(52) U.S. Cl. CPC H04W 40/24; H04W 4/90

(57) ABSTRACT

Systems and methods for device connectivity in emergency situations can include a plurality of user devices communicatively connected wherein at least a portion of the plurality of user devices are directly and dynamically connected in a non-hierarchic fashion to at least a portion of other devices of the plurality of user devices. The plurality of user devices may cooperate with one another to efficiently route emergency requests, non-emergency information, or the like, from a requesting device to one or more user devices until a network is reached, whereby a server can receive and process the emergency request. The server, upon receiving the emergency request, is operable to send a request (with data) to security user devices associated with security staff and enable a communication path between the requesting device and the security devices. The communication path may comprise a voice, text, notification, and/or video communication.

### CROSS REFERENCE TO RELATED APPLICATIONS

This application claims the benefit of priority to U.S. provisional patent application No. 63/261,997, filed Oct. 1, 2021, the contents of which are herein incorporated by reference.

### BACKGROUND OF THE INVENTION

### 1. Field of the Invention

Embodiments of the invention relate generally to the field of emergency services. More particularly, embodiments of the invention relate to the field of connectivity for mobile safety systems, including systems and methods for device connectivity in emergency situations.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In an emergency situation, a user may have a need to send a message via a network, such as via Wi-Fi®, cellular, or the like. The user, however, may not be within range to communication with such a primary network and, accordingly, would need to change their location or find an alternate means for sending their information.

In view of the foregoing, there is a need for a system and method for communication between a user device and a primary network even when the user device is outside of a typical range of such a primary network.

### SUMMARY OF THE INVENTION

Accordingly, the present invention relates to systems and methods for device connectivity in emergency situations.

According to an exemplary embodiment of the invention, a plurality of user devices is communicatively connected wherein at least a portion of the plurality of user devices are directly and dynamically connected in a non-hierarchic fashion to at least a portion of other devices of the plurality of user devices. The plurality of user devices may cooperate with one another to efficiently route emergency requests from a requesting device to one or more user devices until a network is reached (for example, Wi-Fi® or the Internet) whereby a server can receive and process the emergency request. An emergency request may comprise, at least, location-based information (for example GPS coordinates, triangulated position, last known position, and the like), emergency request details, emergency severity, user profile, and other information, whereby the server, upon receiving the emergency request, is operable to send a request (with data) to one or more security user devices associated with security staff and enable a communication path between the requesting device and at least one of the security devices. The communication path may comprise a voice, text, notification, and/or video communication.

In other embodiments, a requesting device may provide non-emergency information to authorized devices (for example, friends associated with authorized devices, connection in a social matrix, or master devices requiring non-emergency information). Non-emergency information may include information such as geolocation based on sensors from a GPS sensor, triangulated position, last known position, predicted next-position, and the like. In some embodiments, non-emergency information may be user-inputted messages (for example, status messages). In some embodiments, non-emergency information may function in a “heartbeat” fashion where automated updates are executed to provide automated information in pre-configured intervals and/or a pre-configured time range. In other embodiments, non-emergency information may include triggers based on location or some other information, for example, the requesting device enters a pre-configured location or geofence, or an establishment.

Embodiments of the present invention provide a method for mesh-based communication comprising determining, by a first user device, nearby ones from a plurality of user devices that are operable for connection through one or more communication protocols; identifying each of the nearby ones of the plurality of user devices; determining permissions of the nearby ones to establish a connection level to each; establishing a social matrix of all of the nearby ones of the plurality of user devices; determining, by the first user device, if a direct connection to a primary network is available; if the direct connection is available, sending a message from the first user device to the primary network; and if the direct connection is not available, determining which connected user devices of the plurality of users in the social matrix is connected, either directly or through others of the plurality of users, to the primary network and sending the message from the first user device to one of the connected user devices.

Embodiments of the present invention further provide a mesh-based communication system comprising a plurality of user devices; a primary network in communication with at least one of the plurality of user devices; one or more security devices in communication with the primary network; a controller operable to route and process a request from a first one of the plurality of user devices and a request from the one or more security devices, wherein the first user device is configured to determine if a direct connection to a primary network is available; if the direct connection is available, a message is sent from the first user device to the primary network; and if the direct connection is not available, determining which connected user devices of the plurality of users are connected, either directly or through others of the plurality of users, to the primary network and sending the message from the first user device to one of the connected user devices.

In some embodiments, the communication system can find the best available network to send a help request or message to another user or a web-based dispatch platform. The communication system can further enable communication between dispatch and the user using the same methodology.

These and other features, aspects and advantages of the present invention will become better understood with reference to the following drawings, description and claims.

### BRIEF DESCRIPTION OF THE DRAWINGS

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a block diagram illustrating an exemplary hardware architecture of a computing device used in an embodiment of the invention;

FIG. 2 is a block diagram illustrating an exemplary logical architecture for a client device, according to an embodiment of the invention;

FIG. 3 is a block diagram showing an exemplary architectural arrangement of clients, servers, and external services, according to an embodiment of the invention;

FIG. 4 is another block diagram illustrating an exemplary hardware architecture of a computing device used in various embodiments of the invention;

FIG. 5 is a block diagram illustrating a system architecture for mesh-based emergency response, according to an exemplary embodiment of the invention;

FIG. 6 is a flow diagram illustrating a method for finding a network connected device in a mesh-based emergency response system, according to an exemplary embodiment of the invention;

FIG. 7 is a flow diagram illustrating a method for communicatively connecting authorized device connections in a mesh-based emergency response system, according to an exemplary embodiment of the invention;

FIG. 8 is a flow diagram illustrating a method for automated communication to a master device in a mesh-based emergency response system, according to an exemplary embodiment of the invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide systems and methods for device connectivity in emergency situations that can include a plurality of user devices communicatively connected wherein at least a portion of the plurality of user devices are directly and dynamically connected in a non-hierarchic fashion to at least a portion of other devices of the plurality of user devices. The plurality of user devices may cooperate with one another to efficiently route emergency requests, non-emergency information, or the like, from a requesting device to one or more user devices until a network is reached, whereby a server can receive and process the emergency request. The server, upon receiving the emergency request, is operable to send a request (with data) to security user devices associated with security staff and enable a communication path between the requesting device and the security devices. The communication path may comprise a voice, text, notification, and/or video communication.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

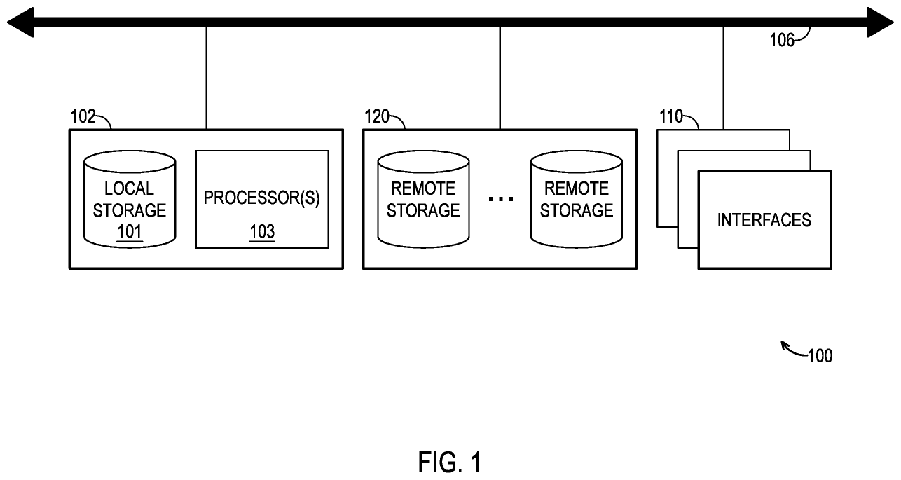

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel®, ARM®, Qualcomm®, and AMD® families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm® SNAPDRAGON® or Samsung EXYNOS® CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE®, THUNDERBOLT®, PCI, parallel, radio frequency (RF), BLUETOOTH®, near-field communications (e.g., using near-field magnetics), 802.11 (Wi-Fi®), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

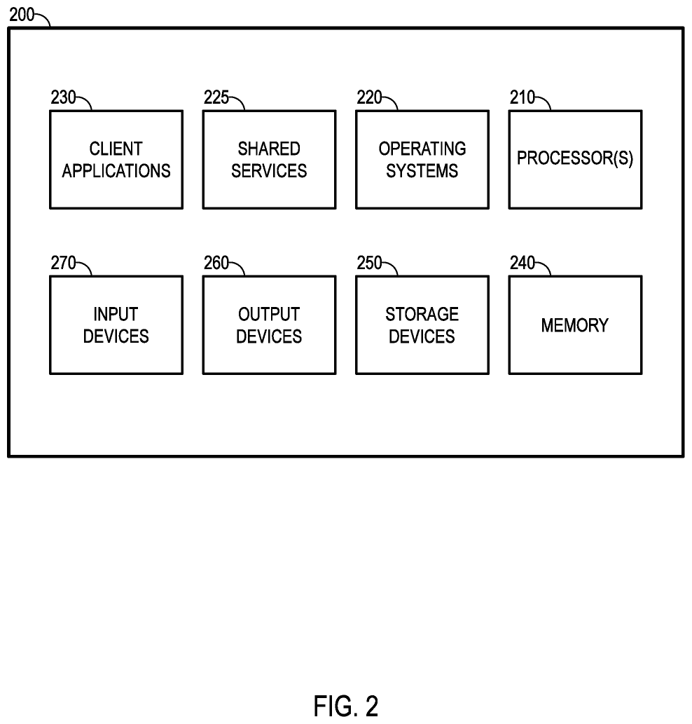

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS® operating system, Apple's Mac® OS/X or iOS operating systems, some variety of the Linux operating system, Google's ANDROID® operating system, or the like. In many cases, one or more shared services 225 may be operable in system 200, and may be useful for providing common services to client applications 230. Services 225 may for example be WINDOWS® services, user-space common services in a Linux® environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

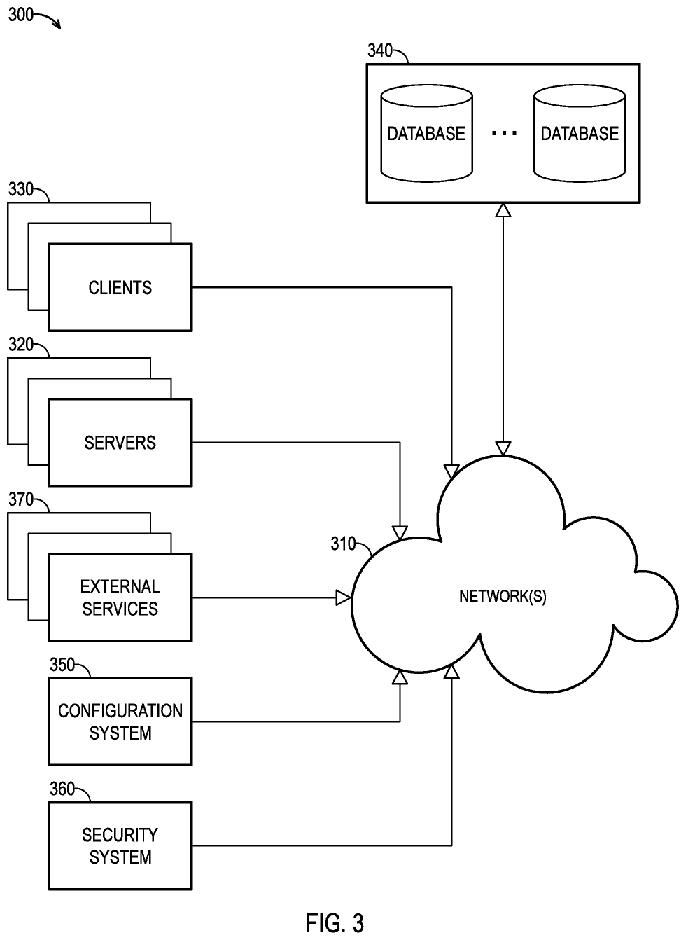

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi®, Wimax®, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

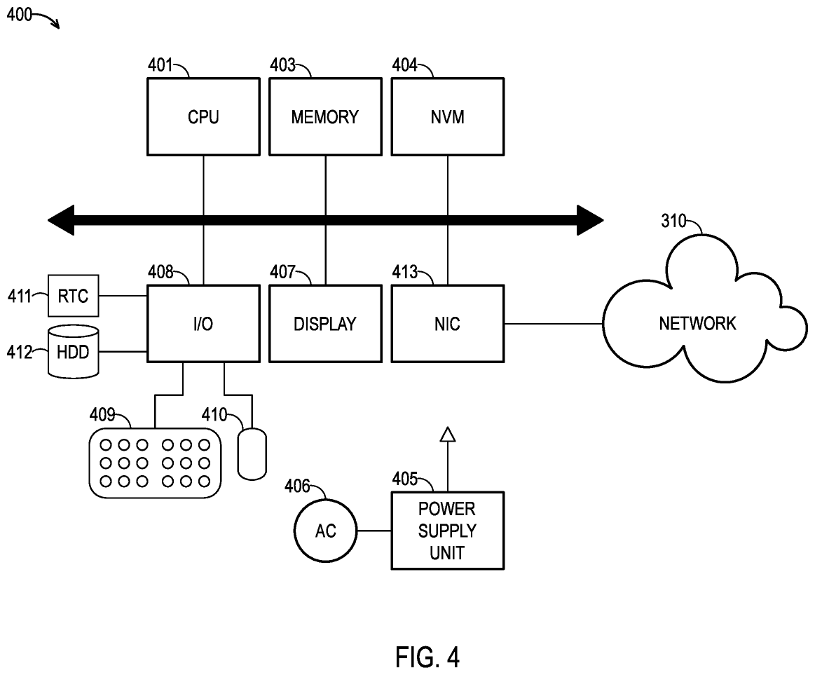

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

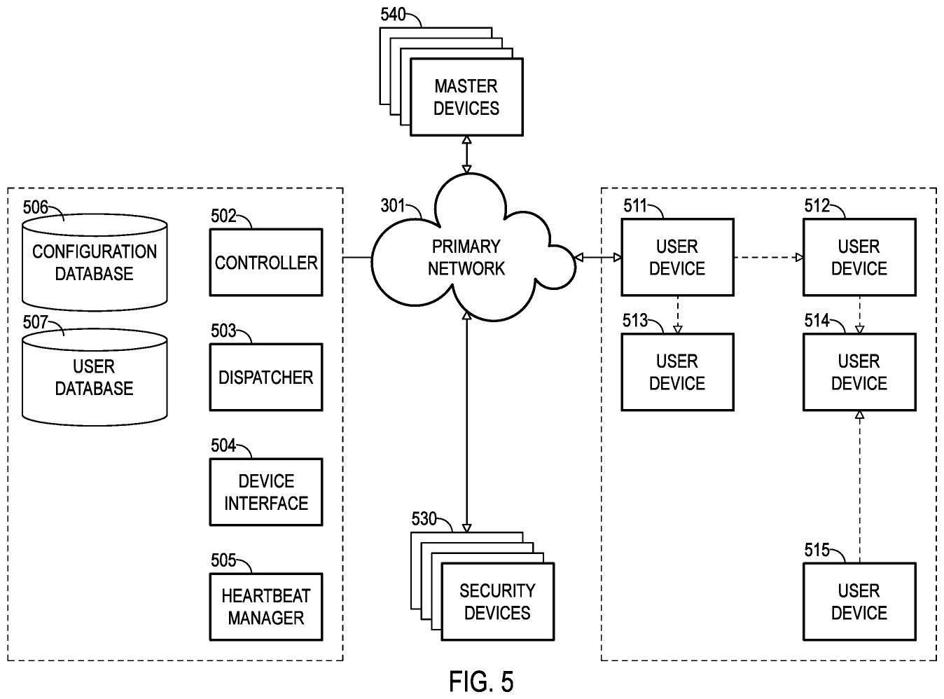

FIG. 5 is a block diagram illustrating a system architecture for mesh-based emergency response, according to an exemplary embodiment of the invention. According to the embodiment, a system 500 for mesh-based emergency response comprises: primary network 310 which may be a Wi-Fi® network, a cellular network, the internet or the like; user devices 511-515 which may be a plurality of user devices (for example, mobile computing devices) communicatively connected in a mesh-type arrangement via a short-range wireless interconnect protocol such as Bluetooth®, NFC, a private internet protocol network, or the like. Connectivity between user devices 511-515 may be based on proximity or capability to connect to another device. For example, user device 511 may be the only user device within proximity of primary network 310 whereas user device 513 may only have a capability to connect to user device 511 through, for example, Bluetooth®. Accordingly, if user device 513 required communication through primary network 310, programming instructions on user device 511 may receive and automatically forward requests to, for example, controller 502, master device 540, or some other system component. It should be noted that requests from a user device may comprise emergency or non-emergency information comprising information such as location (for example current location based on GPS, last known location, etc.), a request to establish a text, voice, or video communication, or the like.

Master devices 540, in some embodiments, may dictate the configuration or behavior of one or more user devices 511, for example, configuring geofences for notification, parameters around heartbeat functionality, notifications and the like. Controller 502 performs system function to route and process requests from user devices 511-515, master devices 540 and security devices 530.

Dispatcher 503 may use location information received from a requesting device (for example, a user device 511) and deliver the location to a first security device 530. In some embodiments, dispatcher 503 may provide and relay real-time location information to the first security device 530. Security devices 530 may be user devices configured to receive security requests from controller 502. Security devices may be specially programmed computers with enhanced capability to identify location of a user device. In some embodiments, first security device 530 may take over a mesh connection to a requesting device and deliver alerts directly.

Device interface 504 may manage connectivity to connected user devices, security devices, and master devices. Heartbeat manager 505 may manage heartbeats from connected devices and determine to which master device they must be forwarded to. Configuration database 506 comprises configuration information for at least a portion of system components, user devices, security devices and master devices. User database 507 comprises information related to registered and connected users, social connections between users, device configuration, relationships between master devices and user devices, and the like.

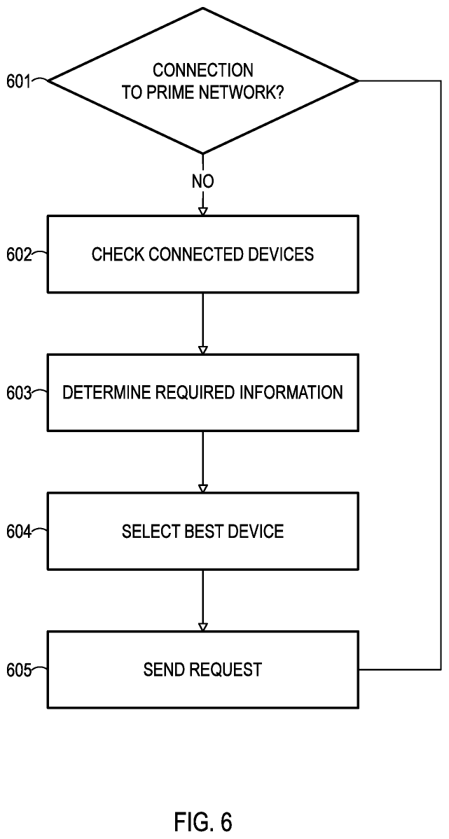

FIG. 6 is a flow diagram illustrating a method for finding a network connected device in a mesh-based emergency response system, according to an exemplary embodiment of the invention. According to the embodiment, in a first step 601, user device 512 determines whether a connection to primary network 310 is available. If it is not, an analysis of currently connected devices 511 and 514 is preformed, in step 602 to determine if there is an indirect connection to primary network 310. In this exemplary embodiment, it is determined that user device 511 has a connection to primary network 310. In a next step 603, device 512 determines the required information for delivery. This information may comprise emergency-level information in search of security services (for example, from a first security device 530), or a heartbeat signal to a master device 540, or communication with another system component. In a next step 604, if more than one conduit to primary network 310 is available (not shown), user device 512 may select a best device to use as a conduit for communication, for example, a selection may be based on a length of duration that a device is in direct contact with primary network 310, be based on permission by a particular device, based on proximity of devices, or some other information. In a next step 605, user device 512 sends a request to controller 502 which, depending on the service request, may communicate to dispatcher 503 to determine a best device to handle the request. Determining the best device may comprise a decision based on location, condition, distance, or some other information.

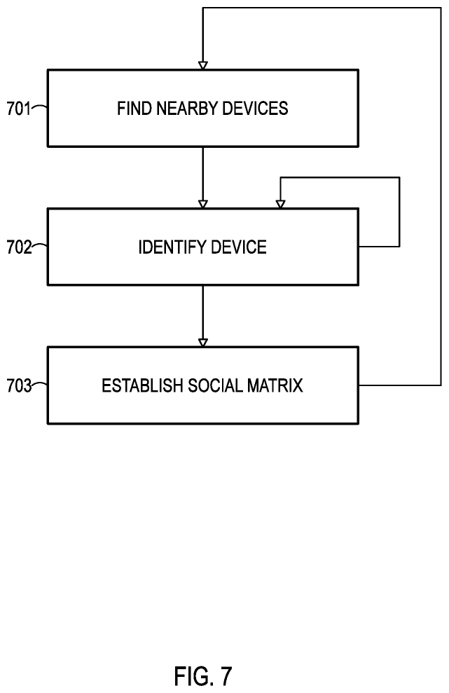

FIG. 7 is a flow diagram illustrating a method for communicatively connecting authorized device connections in a mesh-based emergency response system, according to an exemplary embodiment of the invention. According to the embodiment, in a first step 701, a first device determines nearby devices that are operable for connection through one or more communication protocols (for example, via Wi-Fi®, Bluetooth®, NFC) or some other interconnect protocol. For each device, the device is identified, and permissions are determined, in step 702, to establish connection level (e.g., friend, relay device, or some other designation). Once all reachable devices are considered, a social matrix of all connected devices is established in step 702.

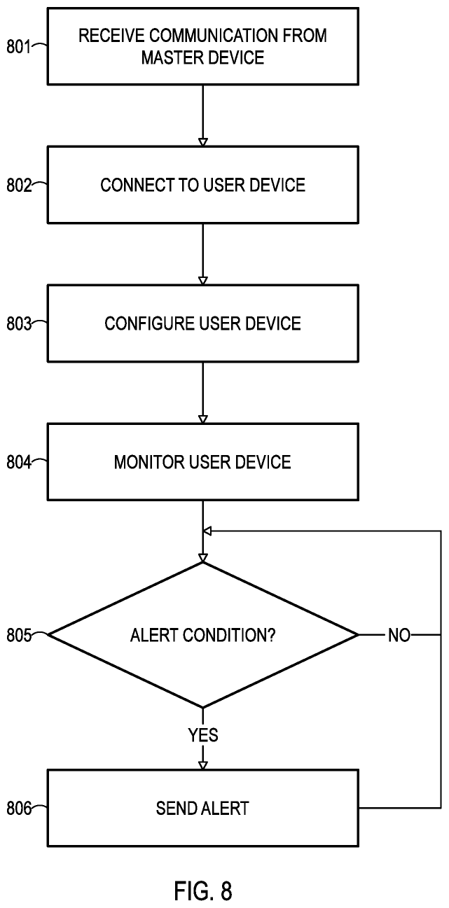

FIG. 8 is a flow diagram illustrating a method for automated communication to a master device in a mesh-based emergency response system, according to an exemplary embodiment of the invention. According to the embodiment, communication is received, at controller 502 from a first master device 801 designating at least one user device to monitor. In a next step 802, a connection to the at least one user device is established. In a next step 803, configuration for the at least one user device (for example, heartbeat frequency, geofence alerts, and the like) is received by controller 502 from first master device 540. In a next step 804, controller 502 monitors the at least one user device for any alert conditions in step 805. Further, heartbeat manager 505 requests a heartbeat from the at least one user device based on the configuration from step 803. If, in step 805 an alert is received from the at least one user device, an alert is sent, in step 806, to the first master device 540.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for mesh-based communication comprising:
determining, by a first user device, nearby ones from a plurality of user devices that are operable for connection through one or more communication protocols;
identifying each of the nearby ones of the plurality of user devices;
determining permissions of the nearby ones to establish a connection level to each;
establishing a social matrix of all of the nearby ones of the plurality of user devices;
determining, by the first user device, if a direct connection to a primary network is available;
if the direct connection is available, sending a message from the first user device to the primary network; and
if the direct connection is not available, determining which connected user devices of the plurality of users in the social matrix is connected, either directly or through others of the plurality of users, to the primary network and sending the message from the first user device to one of the connected user devices.

2. The method of claim 1, wherein the message includes at least one of emergency information, non-emergency information, current location, last known location, a request to establish a text communication, a request to establish a voice communication and a request to establish a video communication.

3. The method of claim 1, further comprising dictating a configuration or a behavior of one or more of the plurality of user devices with a master device.

4. The method of claim 3, wherein the configuration or the behavior includes at least one of a geofence configuration, notification parameters and parameters around a heartbeat functionality.

5. The method of claim 1, further comprising routing and processing requests from the first user device with a controller.

6. The method of claim 1, further comprising delivering location information from the first user device to a first security device via a dispatcher.

7. The method of claim 6, wherein the dispatcher provides and relays real-time location information to the first security device.

8. The method of claim 1, further comprising receiving a security request from the first user device.

9. The method of claim 8, wherein the security request is received from a controller, the controller operable to route and process requests from the first user device.

10. The method of claim 6, further comprising connecting the first security device directly, via the mesh-based communication between the plurality of user devices, to the first user device.

11. The method of claim 1, further comprising managing connectivity between connected user devices, between one or more security devices, and between one or more master devices with a device interface.

12. The method of claim 11, further comprising managing heartbeats from devices connected to the device interface with a heartbeat manager.

13. The method of claim 1, further comprising storing configuration information for the plurality of user devices, one or more security devices and one or more master devices in a configuration database.

14. The method of claim 1, further comprising storing information related to the plurality of user devices, the social matrix, device configurations and relationships between one or more master devices and each of the plurality of user devices in a user database.

15. The method of claim 1, wherein the mesh-based communication system is a mesh-based emergency response system, wherein one or more security devices are provided with the information provided by the first user device.

16. The method of claim 1, wherein the connected user device is chosen by the first user device based on at least one of a length of duration that the connected user device is in direct contact with the primary network, on a permission set on the connected user device, and on a proximity of the connected user device.

17. A mesh-based communication system comprising:
a plurality of user devices;
a primary network in communication with at least one of the plurality of user devices;
one or more security devices in communication with the primary network;
a controller operable to route and process a request from a first one of the plurality of user devices and a request from the one or more security devices, wherein
the first user device is configured to determine if a direct connection to a primary network is available;
if the direct connection is available, a message is sent from the first user device to the primary network; and
if the direct connection is not available, determining which connected user devices of the plurality of users are connected, either directly or through others of the plurality of users, to the primary network and sending the message from the first user device to one of the connected user devices.

18. The mesh-based communication system of claim 17, further comprising a master device configured to dictate a configuration or a behavior of one or more of the plurality of user devices.

19. The mesh-based communication system of claim 17, further comprising a device interface operable to manage connectivity between the connected user devices, between the one or more security devices, and between one or more master devices.

20. The mesh-based communication system of claim 17, further comprising a heartbeat manager operable to manage heartbeats from devices connected to the device interface.
